(19) United States
(12) Patent Application Publication
(10) Pub. No.: US 2014/0131413 A1
(43) Pub. Date: May 15, 2014

(54) METHOD AND DEVICE FOR PRODUCING EDGE CUTOUTS IN SHEET GLASS

(71) Applicants: Leopold Mader, Neuhofen/Ybbs (AT); Alexander Kronsteiner, Blindenmarkt (AT); Markus Jandl, Viehdorf (AT)

(72) Inventors: Leopold Mader, Neuhofen/Ybbs (AT); Alexander Kronsteiner, Blindenmarkt (AT); Markus Jandl, Viehdorf (AT)

(73) Assignee: LISEC AUSTRIA GMBH, Seitenstetten (AT)

(21) Appl. No.: 14/127,011

(22) PCT Filed: May 15, 2012
(86) PCT No.: PCT/AT2012/000134

§ 371 Date: Dec. 17, 2013

(30) Foreign Application Priority Data
Sep. 12, 2011 (AT) A 1305/2011

(51) Int. Cl. C03B 33/023; C03B 33/033

(52) U.S. Cl. CPC C03B 33/023; C03B 33/033
USPC 225/2; 225/96.5

(57) ABSTRACT

To produce an edge cutout, in the shape of a segment of a circle in a glass pane, a cutting tool having a small cutting wheel is used to produce a circular arc-shaped score line, whose ends lie at the edge of the glass pane. By applying pressure to the region defined by the score line from the face having the score line and by counter-pressure from the opposite face, the part of the glass pane defined by the edge and the score line is separated from the glass pane. A device for carrying out the method, includes the small cutting wheel on a support and a head movable into an operative position to break out the portion in the shape of a segment of a circle, and a punch that can be extended from a support for the glass pane and engages on the face opposite the score line.

The invention relates to a method and a device that is suitable for executing the method and with which an edge cutout can be produced in a glass pane (sheet glass).

For example, it is advantageous for making contact between photovoltaic elements provided between the glass panes if the contact strips routed out of the intermediate space between the glass panes are located within the boundary of the glass panes in order to avoid damaging the contact strips. This presupposes that in one of the two glass panes, a cutout is produced in which the contact strips or their ends can come to rest.

In the prior art, cutting parts out of the glass panes is known. Thus, WO 2001/098368 A1 describes a method and a device with which round parts that lie within the glass pane can be broken out of the glass panes in order to produce round holes within the glass pane.

The object of the invention is to devise a method and a device with which edge cutouts can be easily and reliably produced.

This object is achieved according to the invention with a method with the features of claim 1 and with a device that contains the features of the independent claim that is aimed at the device.

Preferred and advantageous configurations of the invention are the subject matter of the dependent claims.

With use of the method according to the invention, especially if the device according to the invention is used, an edge cutout, especially an arc-shaped edge cutout, can be produced in a glass pane.

In one preferred embodiment, in the method according to the invention, for example, the following steps are carried out:

fixing the glass pane on a support surface,

producing a curved, especially an arc-shaped, score line whose ends lie on a segment of the edge of the glass pane that is located between two adjacent corners of the glass pane,

breaking out of the glass pane the part that yields the cutout and that is bordered by the score line and the segment of the edge of the glass pane that lies between the ends of the score line, and

removing the broken-out part of the glass pane.

The method according to the invention can—in one embodiment—be characterized in that the glass pane is fixed on the support surface by negative pressure.

The method according to the invention can—in one embodiment—be characterized in that a score line is produced whose ends lie on a segment of the edge of the glass pane that is located between two adjacent corners of the glass pane.

The method according to the invention can—in one embodiment—be characterized in that a curved, especially an arc-shaped, score line is produced.

The method according to the invention can—in one embodiment—be characterized in that to break out the part yielding the cutout in the region of the score line from the side opposite the score line and at the same time in the region of the part that is to be broken out and that yields the segment of the glass pane from the side bearing the score line, pressure is applied to the glass pane.

The method according to the invention can—in one embodiment—be characterized in that in the region of the score line, pressure is applied to the glass pane by at least one punch that can be extended out of the support surface.

The method according to the invention can—in one embodiment—be characterized in that in the region of the part that is to be broken out and that yields the cutout, pressure is applied to the side of the glass pane that bears the score line by a head that can be moved perpendicular to the support surface.

The method according to the invention can—in one embodiment—be characterized in that to produce the score line, a cutting tool, especially a cutting wheel, is used and that the cutting wheel for scoring the glass pane is advanced onto the support surface and is moved along a path that corresponds to the score line that is to be produced.

The method according to the invention can—in one embodiment—be characterized in that the glass pane is aligned horizontally when the cutout is produced.

The method according to the invention can—in one embodiment—be characterized in that the glass pane is aligned to the vertical at an acute angle, especially an angle of roughly 5°, when the cutout is produced.

The device according to the invention can—in one embodiment—be characterized by the following:

a support surface for glass panes,

at least one apparatus in the support surface for fixing the glass pane on the support surface,

a cutting tool for producing a score line in the side of the glass pane that faces away from the support surface,

an apparatus for guiding the cutting tool along a path corresponding to the score line to be produced, the ends of which path lie on the edge of the glass pane, and

an apparatus for breaking out the part that yields the cutout and that is bordered by the score line and the segment of the edge of the glass pane that lies between the ends of the score line.

The device according to the invention can—in one embodiment—be characterized in that the apparatus for fixing the glass pane on the support surface comprises at least one suction head on which a negative pressure can act.

The device according to the invention can—in one embodiment—be characterized in that the cutting tool comprises a cutting wheel.

The device according to the invention can—in one embodiment—be characterized in that the apparatus for guiding the cutting tool has a holder and that the holder can be pivoted around an axis that is perpendicular to the plane of the support surface.

The device according to the invention can—in one embodiment—be characterized in that the holder is located on a carrier arm that proceeds from the axis.

The device according to the invention can—in one embodiment—be characterized in that the distance of the holder from the axis is adjustable.

The device according to the invention can—in one embodiment—be characterized in that the cutting tool on the holder can be moved by means of a linear motor, especially a hydraulic cylinder, perpendicular to the plane of the support surface.

The device according to the invention can—in one embodiment—be characterized in that the apparatus for breaking out the part of the glass pane that yields the cutout has a punch that can be moved out of the support surface and a head that can be moved perpendicular to the support surface toward the support surface.

The device according to the invention can—in one embodiment—be characterized in that the head is located on the holder for the cutting tool and in that the head can be moved into one and out of one action position.

The device according to the invention can—in one embodiment—be characterized in that the head is attached to an arm that is arranged to be able to pivot on the holder.

The device according to the invention can—in one embodiment—be characterized in that the head in its action position has a shorter distance from the support surface than the cutting tool.

The device according to the invention can—in one embodiment—be characterized in that there is a gripper, in that the gripper can be placed against the broken-out part of the glass pane, and in that the gripper together with the broken-out part of the glass pane can be moved away from the glass pane.

The device according to the invention can—in one embodiment—be characterized in that the support surface is aligned horizontally.

The device according to the invention can—in one embodiment—be characterized in that the support surface is aligned to the vertical at an acute angle, especially an angle of roughly 5°.

In particular, when the method according to the invention is carried out, for example, the procedure can be followed as described below, and a device that is likewise described by way of example below can be used.

In order to produce a cutout on the edge of a glass pane, which cutout is bordered by a (curved) line whose ends lie on the edge of the glass pane and between two adjacent corners of the glass pane, the procedure is, for example, as follows:

A glass pane is fixed using a fastening device, especially at least one suction head, in the device (for example, to or on a support surface), the edge of the glass pane being supported, especially underpinned, from underneath by a support surface (table) (at least) when the score line, especially an arc-shaped score line, is being produced.

In this case, it is provided within the scope of the invention that the ends of the line, by which the edge cutout is bordered toward the glass pane (corresponds to the score line produced beforehand), lie on one (straight) edge of the glass pane that lies between two adjacent corners of the glass pane.

To carry out the scoring effort, there is a cutting tool (for example, a cutting wheel) that is mounted to be able to be raised and lowered via a holder on a hydraulic cylinder perpendicular to the glass pane. The hydraulic cylinder itself is located, for example, via a carrier arm on a column that can be pivoted, for example, around one axis that is perpendicular to the glass pane—and that lies especially outside of the glass pane. The turning capacity of the cutting wheel that is furthermore optionally provided relative to its holder is used to align the cutting wheel such that it can always be tangentially aligned to the (arc-shaped) score line to be produced. The cutting wheel is moved when the cutting work is being performed, for example, by pivoting the column around its pivoting axis so that the carrier arm and the hydraulic cylinder move the cutting wheel that is pressed by the hydraulic cylinder onto the glass pane along an arc via the holder.

After the score line has been produced, the cutting wheel is raised and a head that is likewise fastened on the holder is pivoted into its action position and, by approaching the glass pane, for example from overhead, is placed on the glass pane, specifically in a region that is bordered by the edge of the glass pane and the score line that was produced beforehand.

By moving the holder with the head toward the glass pane, for breaking purposes pressure is applied to the, for example, arc-shaped region of the glass pane that is to be separated so that this region is broken out.

The especially arc-shaped edge cutout is broken out especially reliably when a punch is advanced (raised) out of the support surface on which the glass pane rests and, for example, is held fast by at least one suction head, which punch is placed on the surface that is opposite the score line, for example from underneath, in the region of the score line produced beforehand, on the glass pane, and from the other side, for example from overhead, pressure is applied with the head to the region of the glass pane bordered by the score line so that the edge cutout is broken out with an arc-shaped form.

This working technique can be supplemented by there being a gripper that grasps the edge cutout that has been separated and that removes it from the remaining glass pane.

It can be recognized that with the method according to the invention and especially using the device made according to the invention, easily defined edge cutouts can be produced, and the method steps can be carried out in part or entirely as a result of an automatic control by the individual activities and movements of the device according to the invention being controlled by a control unit. In spite of this, the device according to the invention can also be actuated and operated by hand.

Other details and features of the invention will become apparent from the following description of a preferred embodiment with reference to the attached drawings. Here:

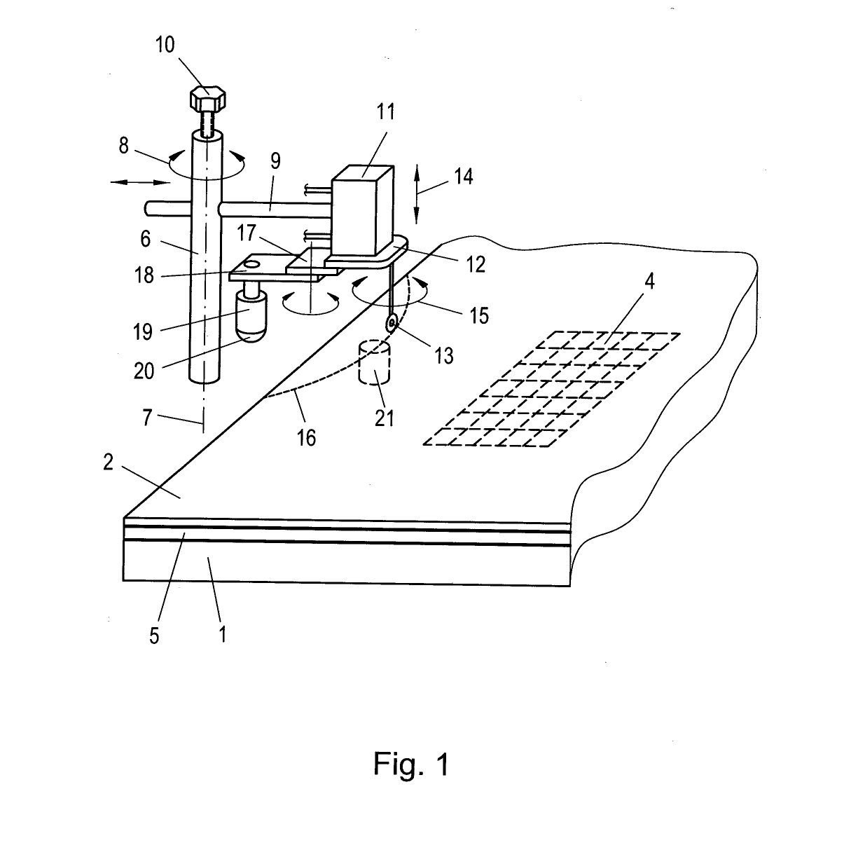

FIG. 1 schematically shows a device according to the invention in the production of a score line,

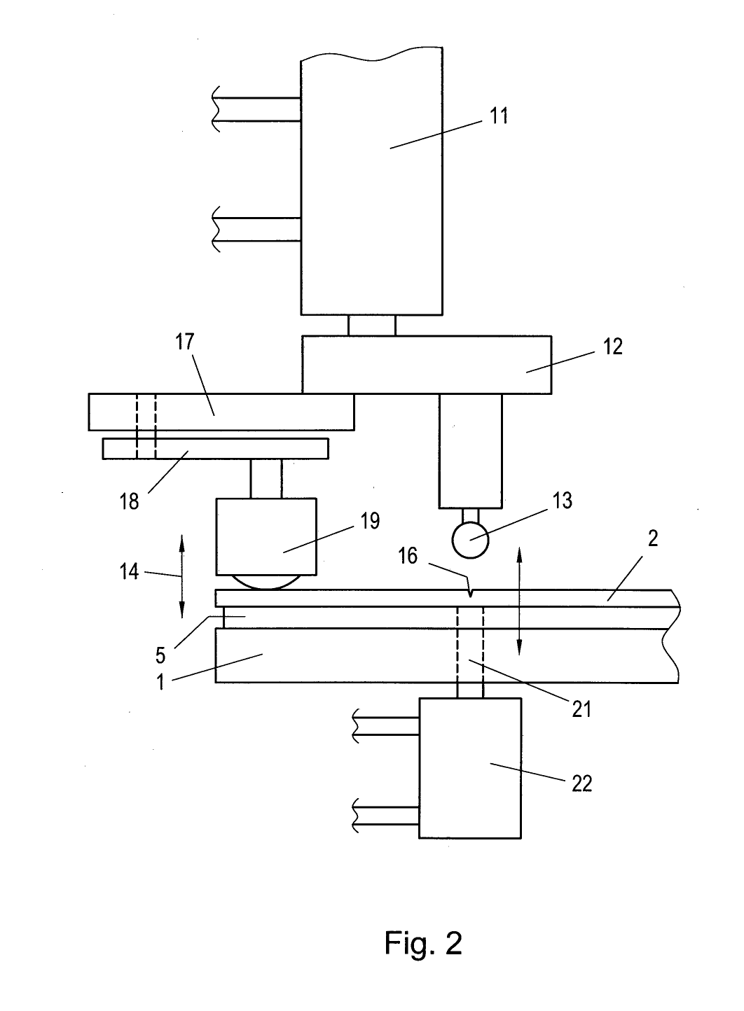

FIG. 2 shows—in a side view—a part of the device according to the invention when the edge section is being broken out, and

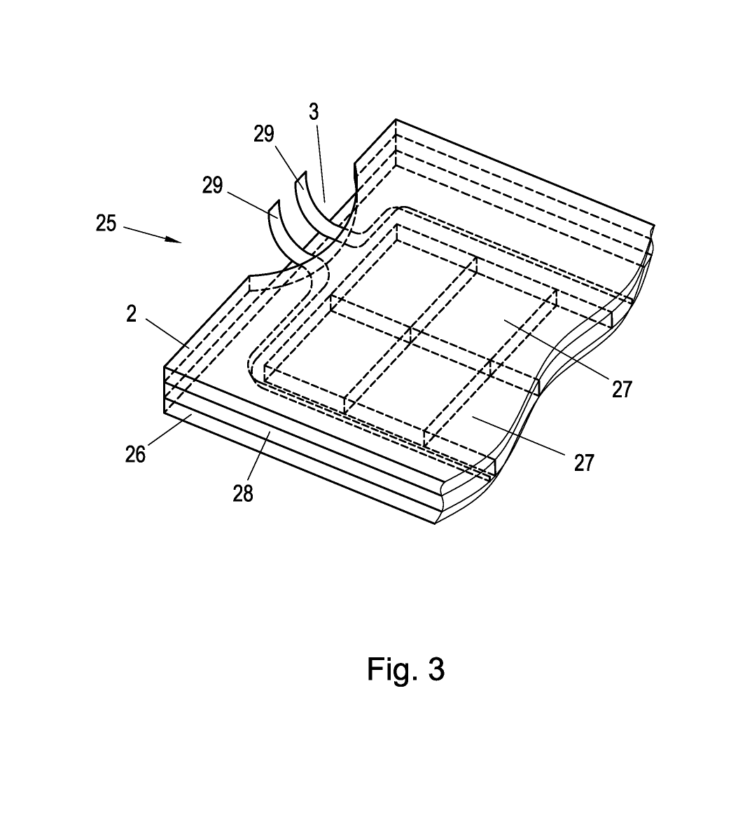

FIG. 3 partially shows a photovoltaic element with an edge cutout in one of its glass panes.

In the embodiment that is shown in FIG. 1, there is a support surface 1 (horizontal, vertical or oblique) for a glass pane 2 (sheet glass pane), in which an edge cutout 3 is to be produced. In the support surface 1, there is at least one apparatus that is made as a suction box 4 for holding the glass pane 2 on the support surface 1. The support surface 1—on its side adjoining the glass pane 2—preferably bears a compliant layer 5 in the form of a felt, a fleece or a foam.

Next to the support surface 1, there is a column 6 that can be pivoted around an axis 7 that is normal (especially perpendicular) to the support surface 1 by a drive that is not shown or by hand in the direction of the double arrow 8. A carrier arm 9 extends through the column 6, and for setting the desired size of the edge cutout 3, it can be fastened in the desired position using a fixing screw 10 in the column 6, i.e., at the desired distance of a cutting tool from the axis 7. On the free end of the carrier arm 9, a hydraulic cylinder 11 is attached that bears a cutting wheel 13 as a cutting tool via a holder 12. The holder 12 can be moved, especially raised and lowered, by action on the hydraulic cylinder 11 in the direction of a double arrow 14, i.e., perpendicular to the plane of the glass pane 2. In addition, the cutting wheel 13 can be turned in the holder around an axis (double arrow 15) that is vertical, for example perpendicular to the plane of the glass pane 2, so that it can be aligned, such that it can be aligned tangentially to the arc-shaped score line 16 that is to be produced.

FIG. 1 shows that in the illustrated example, the ends of the score line 16 are located on one (straight) edge segment of the glass pane 2 that lies between two adjacent corners of the glass pane 2.

On the holder 12 for the cutting wheel 13, an arm 18 is attached to a bracket 17 to be able to pivot, and pointing toward the glass pane 2, for example downward, it bears a head 19 that has a crowned pressure surface 20 on its free side that faces away from the arm 18. The head 19 can be moved by pivoting the arm 18 out of a readiness position (FIG. 1), in which it is located next to the glass pane 2, into an action position (FIG. 2), in which it is located in the region of the glass pane 2. FIG. 2 also shows that the crowned action surface 20 of the head 19 has a smaller distance from the support surface 1 or the glass pane 2 lying there than the cutting wheel 13. Thus, the cutting wheel 13 does not touch the glass pane 2 when the head 19 is placed against the glass pane 2 when an edge cutout 3 is being broken out.

In the support surface 1, extending through the layer 5 provided on the support surface 1, a punch 21 can be moved forward and backward, for example raised and lowered. This punch 21 (FIG. 2) can be moved by a hydraulic cylinder 22 that is mounted on the machine frame (arrow in FIG. 2).

To produce an arc-shaped score line 16, the holder 12 with the cutting wheel 13 is lowered by hydraulic medium acting accordingly on the hydraulic cylinder 11. Then, the column 6 is pivoted by hand or using a drive, so that the cutting wheel 13 is moved along an arc via the carrier arm 9, the hydraulic cylinder 11, and the holder 12, and an arc-shaped score line 16 is produced in the top of the glass pane 2.

As soon as this has taken place, the cutting wheel 13 is raised off the glass pane 2, and the arm 18 with the head 19 is pivoted into the (action) position that is shown in FIG. 2, so that it is located in the region of the glass pane 2 that is bordered by the score line 16. By actuating the hydraulic cylinder 11, the head 19 is lowered in the direction to the glass pane 2 and at the same time the punch 21 is raised off the support surface 1 by actuating a drive, for example a hydraulic cylinder 22, so that the edge cutout 3 that is arc-shaped in the example is broken out of the glass pane 2.

A gripper that is not shown can be added to the device; the gripper grasps and removes the broken-out segment and deposits it, for example, in a collecting tank for glass residues.

FIG. 3 shows (partially) one example for a photovoltaic module 25 that contains two glass panes 26 and 2, and several photovoltaic elements 27 located between them. The interior between the glass panes 26 and 2 in which the photovoltaic elements 21 [sic] are located is closed toward the edge by a strand 28 of sealing compound.

FIG. 3 shows that the strip-shaped conductors 29 for making contact between the photovoltaic elements are routed out in the region of the edge cutout 3 in the upper glass pane 2 and thus do not project above the edge of the photovoltaic module 25; this has the advantageous effect that these conductors 29 (contact strips) are protected.

In summary, one embodiment of the invention can be described as follows:

To produce an edge cutout 3, especially an arc-shaped edge cutout 3 in a glass pane 2, an arc-shaped score line 16 whose ends lie on the edge of the glass pane 2 is produced using a cutting tool with a cutting wheel 13. By applying pressure to the region bordered by the score line 16 from the side of the score line 16 and by counter-pressure from the side opposite the score line 16 in the region of the score line 16, the part of the glass pane 2 bordered by the edge and the score line 16 is separated from the glass pane 2. For executing the method, there is a device that on a carrier 12 has the cutting wheel 13 and a head 19 that can be alternately moved into the action position for breaking out the arc-shaped part (edge cutout 3) and a punch 21 that can be extended out of a support 1 for the glass pane 2 and that engages on the side opposite the score line 16.

1. Method for producing cutouts (3) that are open toward the edge in a glass pane (2), the cutout (3) having especially the shape of a segment of a circle, characterized by the following steps:
fixing the glass pane (2) on a support surface (1),
producing a curved, especially an arc-shaped, score line (16), whose ends lie on a segment of the edge of the glass pane (2) that is located between two adjacent corners of the glass pane (2),
breaking out of the glass pane (2) a part that yields the cutout (3) and that is bordered by the score line (16) and the segment of the edge of the glass pane (2) that lies between the ends of the score line (16), and removing the broken-out part of the glass pane (2).

2. Method according to claim 1, wherein a score line (16) is produced whose ends lie on a segment of the edge of the glass pane (2) that is located between two adjacent corners of the glass pane (2).

3. Method according to claim 2, wherein a curved, especially an arc-shaped, score line (16) is produced.

4. Method according to claim 1, wherein pressure is applied to the glass pane (2) to break out the part yielding the cutout (3) in the region of the score line (16) from the side opposite the score line (16) and at the same time in the region of the part that is to be broken out and that yields the cutout (3) of the glass pane (2) from the side bearing the score line (16).

5. Device for executing the method according to claim 1, characterized by
a support surface (1) for the glass pane (2),
at least one apparatus (4) in the support surface (1) for fixing the glass pane (2) on the support surface (1),
a cutting tool (13) for producing a score line (16) in the side of the glass pane (2) that faces away from the support surface (1),
an apparatus (6, 9, 12) for guiding the cutting tool (13) along a path corresponding to the score line (16) to be produced, the ends of which path lie on the edge of the glass pane (2), and
an apparatus (19, 21) for breaking out the part that yields the cutout (3) and that is bordered by the score line (16)
and the segment of the edge of the glass pane (2) that lies between the ends of the score line (16).

6. Device according to claim 5, wherein the apparatus for fixing the glass pane (2) on the support surface (1) comprises at least one suction head (4) on which a negative pressure can act.

7. Device according to claim 5, wherein the apparatus for guiding the cutting tool (13) has a holder (12) and wherein the holder (12) can be pivoted around an axis (6) that is perpendicular to the plane of the support surface (1).

8. Device according to claim 5, wherein the apparatus for breaking out the part of the glass pane (2) that yields the cutout (3) has a punch (21) that can be moved out of the support surface (1) and a head (19) that can be moved perpendicular to the support surface (1) toward the support surface (1).

9. Device according to claim 8, wherein the head (19) is located on the holder (12) for the cutting tool (13) and wherein the head (19) can be moved into one and out of one action position.

10. Device according to claim 8, wherein the head (19) in its action position has a shorter distance from the support surface (1) than the cutting tool (13).

11. Device according to claim 5, wherein there is a gripper, wherein the gripper can be placed against the broken-out part of the glass pane (2), and wherein the gripper together with the broken-out part of the glass pane (2) can be moved away from the glass pane (2).

12. Device according to claim 5, wherein the support surface (1) is aligned horizontally.

13. Device according to claim 5, wherein the support surface (1) is aligned to the vertical at an acute angle, especially an angle of roughly 5°.
